(19) United States
(12) Patent Application Publication
(10) Pub. No.: US 2026/0155989 A1
(43) Pub. Date: Jun. 4, 2026

(54) CRYPTOGRAPHIC MODEL LINEAGE & TRAINING DATA VERIFIER

(71) Applicant: George William Bickerstaff, III, Greenwich, CT (US)

(72) Inventor: George William Bickerstaff, III, Greenwich, CT (US)

(21) Appl. No.: 19/455,261

(22) Filed: Jan. 21, 2026

(51) Int. Cl. H04L 9/32

(52) U.S. Cl. CPC H04L 9/3236; H04L 9/3213

(57) ABSTRACT

A cryptographic model lineage and training data verifier enforces verification of artificial intelligence model provenance prior to execution. The system computes cryptographic hashes of training data and model artifacts, compares them to approved lineage commitments, and blocks execution upon failure. Only verified models receive clearance to execute beyond an execution boundary.

### TECHNICAL FIELD

The present invention relates to computer-implemented systems for verification and governance of artificial intelligence models deployed in regulated environments.

More particularly, the invention relates to hardware-enforced systems that cryptographically verify training data provenance, model lineage, and reproducibility prior to permitting model initialization or inference execution.

The invention ensures that only validated and authorized artificial intelligence models may operate beyond an execution boundary.

### BACKGROUND

Artificial intelligence systems increasingly rely on complex training pipelines involving large datasets, iterative retraining, and distributed computational resources.

In regulated environments, it is critical to verify that deployed models are derived from approved training data and validated model architectures.

Existing approaches typically rely on documentation, metadata tracking, or post-hoc audits to establish provenance.

Such approaches are vulnerable to error, omission, or intentional tampering, and do not prevent unauthorized models from executing in real time.

Software-level provenance tracking lacks isolation from host systems and may be bypassed or altered.

There exists a need for a deterministic mechanism that verifies training data integrity and model lineage before a model is allowed to initialize or generate outputs.

The present invention addresses these deficiencies by providing a cryptographic model lineage and training data verifier enforced at an execution boundary.

### SUMMARY OF THE INVENTION

The disclosed invention provides a cryptographic verification system for artificial intelligence model lineage and training data provenance.

The system validates cryptographic hashes of training datasets and model artifacts against immutable reference commitments prior to model initialization.

Verification is performed within a hardware-isolated execution environment to prevent tampering or bypass.

If verification fails, the system deterministically blocks model execution and generates a violation signal.

Successful verification results in issuance of a clearance token permitting execution beyond an execution boundary.

### DEFINITIONS

Clearance Token means a cryptographically verifiable artifact authorizing model initialization or inference execution.

Execution Boundary means a control point at which model initialization or inference output would affect downstream systems.

Hardware-enforced verifier means a verification component operating within a trusted execution environment.

Lineage Commitment means an immutable cryptographic reference representing approved model architecture and training context.

Model Artifact means a serialized representation of a trained artificial intelligence model.

Model Version Identifier means a unique identifier bound to a specific model artifact and lineage commitment.

Training Dataset Hash means a cryptographic hash representing the contents of a training dataset.

Trusted Execution Environment means a hardware-protected execution environment isolated from host systems.

Verification failure means a mismatch between computed and approved cryptographic references.

### BRIEF DESCRIPTION OF THE DRAWINGS

FIG. 1 illustrates lineage verification architecture.

FIG. 2 illustrates training data verification.

FIG. 3 illustrates model artifact verification.

FIG. 4 illustrates execution boundary enforcement.

FIG. 5 illustrates audit and clearance issuance.

### DETAILED DESCRIPTION OF THE DRAWINGS

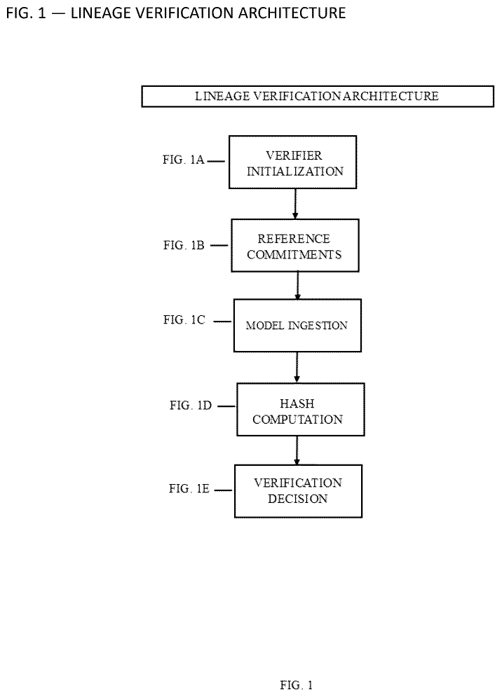

### FIG. 1—Lineage Verification Architecture

FIG. 1A—VERIFIER INITIALIZATION illustrates initialization of a hardware-enforced verifier within a trusted execution environment. The verifier is isolated from host operating systems. This prevents tampering.

FIG. 1B—REFERENCE COMMITMENTS illustrates loading of immutable lineage commitments into protected memory. The commitments represent approved model configurations. Unauthorized modification is prevented.

FIG. 1C—MODEL INGESTION illustrates ingestion of a model artifact for verification. The artifact is received prior to initialization. Execution is paused pending verification.

FIG. 1D—HASH COMPUTATION illustrates computation of cryptographic hashes for model artifacts and training data. Hashes are computed inside the trusted execution environment. External access is blocked.

FIG. 1E—VERIFICATION DECISION illustrates generation of a verification decision based on hash comparison. A pass permits progression. A failure blocks execution.

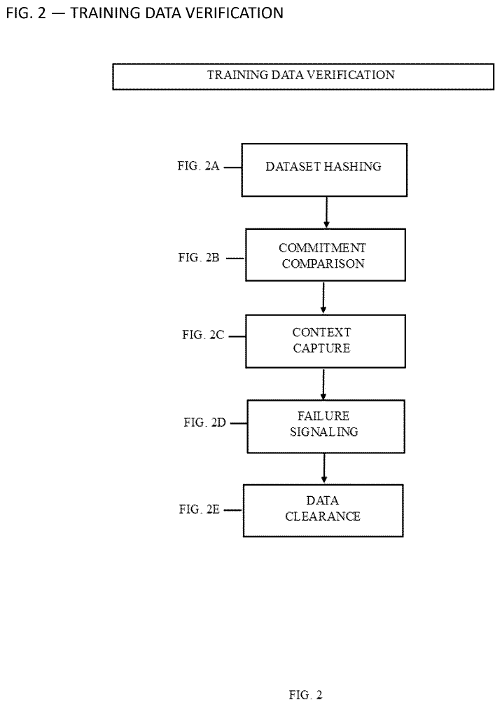

### FIG. 2—Training Data Verification

FIG. 2A—DATASET HASHING illustrates hashing of training datasets prior to model initialization. Hashing occurs within the verifier. Dataset integrity is preserved.

FIG. 2B—COMMITMENT COMPARISON illustrates comparison of computed dataset hashes against approved lineage commitments. A match indicates approved provenance. A mismatch triggers failure.

FIG. 2C—CONTEXT CAPTURE illustrates capture of contextual metadata associated with training data. Metadata may include source, jurisdiction, or time. Context is bound to the verification record.

FIG. 2D—FAILURE SIGNALING illustrates generation of a violation signal upon dataset verification failure. Execution is halted. Downstream systems are protected.

FIG. 2E—DATA CLEARANCE illustrates clearance of training data verification upon successful comparison. Clearance permits further verification steps. No inference occurs yet.

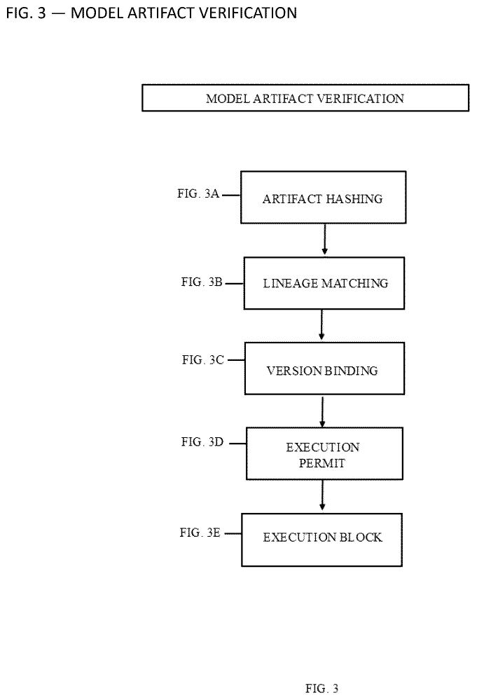

### FIG. 3—Model Artifact Verification

FIG. 3A—ARTIFACT HASHING illustrates hashing of the model artifact. Hashing occurs prior to loading model parameters. The artifact is not executed.

FIG. 3B—LINEAGE MATCHING illustrates matching of artifact hashes to approved lineage commitments. Matching ensures reproducibility. Unauthorized artifacts are rejected.

FIG. 3C—VERSION BINDING illustrates binding of a model version identifier to the verified artifact. The identifier cryptographically links lineage and execution. Traceability is ensured.

FIG. 3D—EXECUTION PERMIT illustrates generation of an execution permit following successful verification. The permit is temporary and scoped. Execution boundaries remain enforced.

FIG. 3E—EXECUTION BLOCK illustrates deterministic blocking of execution upon verification failure. The model is never initialized. Safety is preserved.

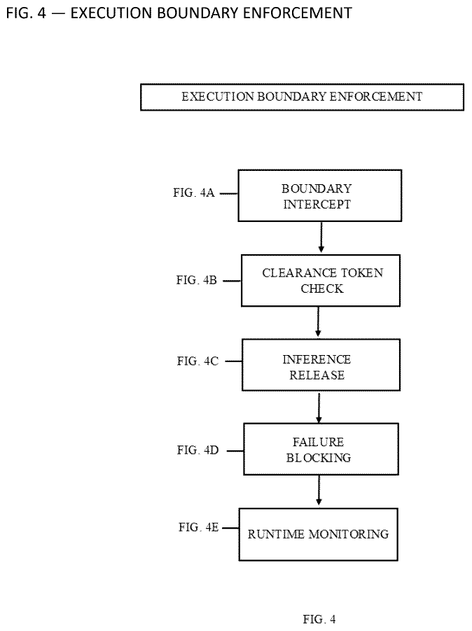

### FIG. 4—Execution Boundary Enforcement

FIG. 4A—BOUNDARY INTERCEPT illustrates interception of model

initialization at an execution boundary. Verification is required prior to crossing the boundary. Execution is gated.

FIG. 4B—CLEARANCE TOKEN CHECK illustrates verification of a clearance token before allowing execution. Tokens are cryptographically validated. Invalid tokens are rejected.

FIG. 4C—INFERENCE RELEASE illustrates release of inference execution following successful verification. Outputs are permitted beyond the boundary. Governance conditions are satisfied.

FIG. 4D—FAILURE BLOCKING illustrates blocking of inference upon verification failure. Outputs are suppressed. Downstream workflows are protected.

FIG. 4E—RUNTIME MONITORING illustrates monitoring of execution state post-verification. Unauthorized changes invalidate clearance. Execution may be halted.

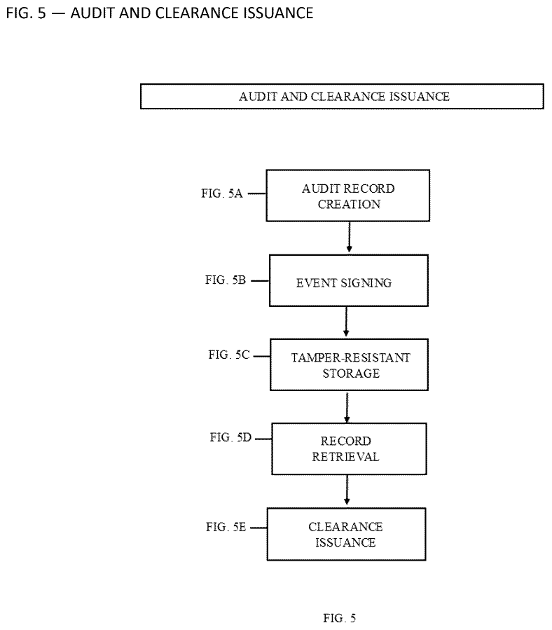

### FIG. 5—Audit and Clearance Issuance

FIG. 5A—AUDIT RECORD CREATION illustrates creation of immutable audit records for each verification event. Records include hashes and decisions. Integrity is enforced.

FIG. 5B—EVENT SIGNING illustrates cryptographic signing of audit records. Signing prevents repudiation. Records are regulator-ready.

FIG. 5C—TAMPER-RESISTANT STORAGE illustrates storage of audit records in protected logs. Logs are append-only. Unauthorized alteration is prevented.

FIG. 5D—RECORD RETRIEVAL illustrates retrieval of audit records for inspection. Retrieval does not alter records. Transparency is preserved.

FIG. 5E—CLEARANCE ISSUANCE illustrates issuance of a clearance token following successful verification. The token authorizes execution. Scope is enforced.

### EXAMPLES

In one example, a diagnostic model is submitted for deployment. The verifier hashes the training dataset and model artifact and matches them against approved commitments. Execution is permitted only after successful verification.

In another example, a model artifact fails lineage verification due to altered training data. The verifier blocks initialization and records a violation event. No inference outputs are generated.

1. A system for verifying artificial intelligence model lineage, comprising:
a hardware-enforced verifier operating within a trusted execution environment;
a cryptographic reference representing approved training data and model lineage; and
logic configured to block model execution unless a computed cryptographic hash matches the reference.

2. A computer-implemented method comprising:
computing a cryptographic hash of a training dataset and a model artifact;
comparing the hash to an approved lineage commitment; and
preventing model initialization when the comparison fails.

3. A verification controller configured to intercept execution at an execution boundary and permit inference only upon verification of a cryptographically valid clearance token bound to a model version identifier.

4. The system of claim 1, wherein verification occurs prior to model parameter loading.

5. The method of claim 2, wherein verification is performed entirely within a trusted execution environment.

6. The verification controller of claim 3, wherein verification failure generates a violation signal recorded in an immutable audit log.

7. The system of claim 1, wherein contextual metadata is cryptographically bound to the verification record.

8. The method of claim 2, wherein verification prevents both model initialization and inference execution.

9. The verification controller of claim 3, wherein the clearance token is scoped to a specific model version and execution context.

10. The system of claim 1, wherein any post-verification modification invalidates the clearance token.
